(19) United States
(12) Patent Application Publication
(10) Pub. No.: US 2023/0027130 A1
(43) Pub. Date: Jan. 26, 2023

(54) METHOD AND SERVER FOR CALCULATING A TRAJECTORY OF AN ARTICULATED ARM OF A ROBOT

(71) Applicant: OMNIROBOTIC INC, LAVAL (CA)

(72) Inventor: Francois SIMARD, LORRAINE (CA)

(21) Appl. No.: 17/381,278

(22) Filed: Jul. 21, 2021

(51) Int. Cl. B25J 9/16

(52) U.S. Cl. CPC B25J 9/1666; B25J 9/1671; B25J 9/1605; B25J 9/1697

(57) ABSTRACT

A computing device stores a kinematic model of a robot comprising an articulated arm and a tool coupled to the arm. The kinematic model comprises a plurality of active joints corresponding to a plurality of actuated joints of the articulated arm, and one or more passive joint. For each passive joint, a nominal joint position and a corresponding tolerance margin is defined, for simulating a tolerance margin applicable to a nominal position and orientation of the tool with respect to an object processed by the tool. The computing device determines a 3D model of the object, determines a toolpath of the tool for performing a task on the object and calculates a trajectory of the articulated arm based on the toolpath, the kinematic model and the 3D model of the object. The calculation takes into account the nominal joint position and the tolerance margin of each passive joint.

### TECHNICAL FIELD

The present disclosure relates to the field of robotics. More specifically, the present disclosure relates to a method and server for calculating a trajectory of an articulated arm of a robot.

### BACKGROUND

The increasing automatization of production processes in various fields (e.g. automotive, aeronautics, consumer goods, food, etc.) leads to an increased usage of robots for performing a variety of tasks.

A robot generally comprises an articulated arm and a tool secured to the articulated arm. The tool performs a task (e.g. painting, welding, coating, etc.) on an object. A toolpath defines a trajectory of a tool center point (TCP) of the tool for performing the task on the object. A trajectory of the articulated arm of the robot is calculated for executing the toolpath.

The tool has a nominal position and orientation with respect to the object for performing the task on the object. The calculation of the trajectory of the articulated arm takes into account the nominal position and orientation of the tool with respect to the object. Furthermore, the calculation of the trajectory of the articulated arm aims at avoiding collisions of the articulated arm or the tool with the object or the surrounding environment (e.g. a wall or a ceiling of a room where the robot is located).

However, due to the constraints imposed by the nominal position and orientation of the tool with respect to the object, a kinematic solution allowing a completion of the task performed on the object may not exist. The kinematic solution defines the trajectory of the articulated arm of the robot. The absence of a kinematic solution may be due to joint limits (limits on joint positions of joints of the robot), collisions or simply because the tool would be out of reach of the robot. In this case, the task can only be performed partially by the robot where a compliant trajectory can be calculated (e.g. 85% of the task).

However, looking at the same task being performed by a human being, the experience proves that it is not necessary for the tool to be at the nominal position and/or orientation with respect to the object for performing the task on the object. Each process has in fact a tolerance margin on the position and/or orientation of the tool with respect to the object, and within this tolerance margin, the task is performed with a satisfying level of quality. Furthermore, this tolerance margin is often leveraged by the human being to reduce his motion amplitude and effectively reduce the effort, fatigue and articulatory stress while performing the task. The process tolerance margin on the position and/or orientation of the tool increases the possibility of finding a trajectory of the articulated arm of the robot allowing completion of the task on the object. Furthermore, the tolerance margin on the position and/or orientation of the tool increases the possibility of finding a trajectory of the articulated arm of the robot that minimizes mechanical stress on components of the articulated arm (e.g. joints of the articulated arm actuated by a motor for executing the trajectory of the articulated arm).

Therefore, there is a need for a new method and server for calculating a trajectory of an articulated arm of a robot.

### SUMMARY

According to a first aspect, the present disclosure relates to a method for calculating a trajectory of an articulated arm of a robot. The method comprises storing in a memory of a computing device a kinematic model of the robot. The robot comprises the articulated arm and a tool coupled to the articulated arm. The articulated arm comprises a plurality of actuated joints in series. The kinematic model comprises a plurality of active joints in series and one or more co-located passive joint. The plurality of active joints respectively corresponds to the plurality of actuated joints. The kinematic model further defines a position and orientation of an operation center point (OCP). The method comprises storing in the memory of the computing device, for each passive joint, a nominal joint position of the passive joint and a tolerance margin with respect to the nominal joint position of the passive joint. The nominal joint position of the one or more passive joint defines a nominal position and orientation of the tool with respect to the object when the tool performs a task on the object. The tolerance margin of the one or more passive joint defines a tolerance margin on at least one of the nominal position and nominal orientation of the tool with respect to the object when the tool performs the task on the object. The method comprises determining a three-dimensional (3D) model of the object. The method comprises determining a toolpath of the tool for performing the task on a target area of the object. The toolpath comprises a plurality of consecutive positions and orientations of a nominal tool point (NTP). Each position and orientation of the NTP corresponds to a position and orientation of the OCP where the joint position of each passive joint is the nominal joint position of the passive joint. The method comprises calculating by a processing unit of the computing device a trajectory of the articulated arm based at least on the toolpath, the kinematic model comprising the plurality of active joints and the one or more co-located passive joint, and the 3D model of the object. The trajectory defines a plurality of consecutive joint positions of the actuated joints of the articulated arm. The calculation of the trajectory takes into account the nominal joint position and the tolerance margin with respect to the nominal joint position of each passive joint.

According to a second aspect, the present disclosure relates to a non-transitory computer program product comprising instructions executable by a processing unit of a computing device, the execution of the instructions by the processing unit providing for calculating a trajectory of an articulated arm of a robot, by implementing the aforementioned method.

According to a third aspect, the present disclosure relates to a computing device comprising memory and a processing unit, the processing unit comprising one or more processor. The processing unit stores in the memory a kinematic model of the robot. The robot comprises the articulated arm and a tool coupled to the articulated arm. The articulated arm comprises a plurality of actuated joints in series. The kinematic model comprises a plurality of active joints in series and one or more co-located passive joint. The plurality of active joints respectively corresponds to the plurality of actuated joints. The kinematic model further defines a position and orientation of an operation center point (OCP). The processing unit stores in the memory, for each passive joint, a nominal joint position of the passive joint and a tolerance margin with respect to the nominal joint position of the passive joint. The nominal joint position of the one or more passive joint defines a nominal position and orientation of the tool with respect to the object when the tool performs a task on the object. The tolerance margin of the one or more passive joint defines a tolerance margin on at least one of the nominal position and nominal orientation of the tool with respect to the object when the tool performs the task on the object. The processing unit determines a three-dimensional (3D) model of the object. The processing unit determines a toolpath of the tool for performing the task on a target area of the object. The toolpath comprises a plurality of consecutive positions and orientations of a nominal tool point (NTP). Each position and orientation of the NTP corresponds to a position and orientation of the OCP where the joint position of each passive joint is the nominal joint position of the passive joint. The processing unit calculates a trajectory of the articulated arm based at least on the toolpath, the kinematic model comprising the plurality of active joints and the one or more co-located passive joint, and the 3D model of the object. The trajectory defines a plurality of consecutive joint positions of the actuated joints of the articulated arm. The calculation of the trajectory takes into account the nominal joint position and the tolerance margin with respect to the nominal joint position of each passive joint.

### BRIEF DESCRIPTION OF THE DRAWINGS

Embodiments of the disclosure will be described by way of example only with reference to the accompanying drawings, in which:

FIG. 1A represents a processing chain carrying objects processed by a robot under the control of a robot controller and a server;

FIG. 1B represents a basic configuration of a real-world robot system comprising some of the components represented in FIG. 1A;

FIG. 2 is a schematic representation of components of the robot of FIG. 1A;

FIG. 3 is a schematic representation of components of the server of FIG. 1A;

FIGS. 4A and 4B are schematic representations of a trajectory calculation software executed by the server of FIG. 1A for controlling the robot of FIG. 1A;

FIGS. 5A, 5B and 5C illustrate a kinematic model of the robot of FIG. 1A comprising active and passive joints;

FIG. 5D represents in a three dimensional space an Operation Center Point and a Nominal Tool Point illustrated in FIGS. 5A, 5B and 5C;

FIGS. 6A and 6B illustrate a tolerance margin in an orientation of a tool with respect to an object processed by the tool;

FIGS. 6C and 6D illustrate a tolerance margin in a position of a tool with respect to an object processed by the tool;

FIG. 6E illustrates a tolerance margin in a position and orientation of a tool with respect to an object processed by the tool; and

FIG. 7 illustrates a method for calculating a trajectory of an articulated arm of the robot of FIG. 1A.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to the positioning of a tool secured to an articulated arm of a robot for performing a task on an object. The tool generally has a nominal position and orientation with respect to a target area of the object for performing the task on the object. The present disclosure aims at taking into consideration a tolerance margin in the position and/or orientation of the tool with respect to the object when calculating a trajectory of the articulated arm of the robot for performing the task on the object.

Throughout the present specification and claims, the following definitions are used:

Process: defines a task performed by a tool on an object and further defines process characteristics for the execution of the task. The task is decomposed into a sequence of elementary operations performed by the tool in accordance with the process characteristics. For example, a painting process defines a task consisting in painting an object. Process characteristics include a shape of a cone of paint generated by the painting tool. Each brushstroke performed by the painting tool is an elementary operation. In another example, a welding process defines a task consisting in performing welding on an object. Process characteristics include characteristics of the electrical arc generated for performing the welding. Each electrical arc generated by the welding tool is an elementary operation.

Process tolerance margin: the process characteristics impose constraints on the execution of the task, including a nominal position and orientation of the tool with respect to the object for performing the task in accordance with the process characteristics. For example, the tool needs to be perpendicular to a surface of the object and at a distance of 5 millimeters from the surface of the object. The process tolerance margin defines a tolerance margin with respect to the nominal position and orientation of the tool with respect to the object. For example, referring to the previous example, the tool does not need to be perfectly orthogonal and/or does not need to be exactly at a distance of 5 millimeters from the surface of the object.

Operation center point (OCP): a point of reference for each elementary operation performed by the tool when executing the task. The OCP is generally located on the tool and referred to as the tool center point (TCP). Alternatively, the OCP is not located on the tool and may be referred to as a virtual TCP. For example, in a painting process, the OCP is a virtual TCP consisting of a point some distance away from the tool from which the paint is projected. In a welding process, the OCP is a TCP consisting of a point on the tool from which the electrical arc is generated. The OCP is an oriented point defining a position and orientation.

Actuated joint: component of an articulated arm of a robot. The actuated joint is actuated by at least one motor and the movement of the articulated joint contributes to a trajectory of the actuated arm of the robot. The motion of the joint is linear or angular.

Active joint: component of a kinematic model of the robot representative of a corresponding actuated joint of the articulated arm of the robot. If the articulated arm of the robot comprises N actuated joints, then the kinematic model comprises N corresponding active joints.

Passive joint: component of the kinematic model used for simulating the process tolerance margin, more specifically the tolerance margin applicable to the nominal position and orientation of the tool (secured to the articulated arm of the robot) with respect to the object being processed by the tool. Contrary to an active joint, the passive joint does not represent a corresponding joint of the articulated arm of the robot.

Target area: area of an object to be processed by the tool secured to the articulated arm of the robot. For example, the target area consists of one or more surface of the object (or portion(s) of one or more surface). If the object has the shape of a cube, the target area may consist of one or more faces of the cube, or one or more portion of at least one face of the cube. In another example, if the object has the shape of a hollow cylinder, the target area may consist of at least one of the inner and outer surface area of the cylinder, or one or more portion of at least one of the inner and outer surface area of the cylinder. Other examples of target areas include one or more edge of the object, one or more summit of the object, etc. For instance, in a painting process, target areas are generally defined as surfaces of the object; while in a welding or deburring process, target areas are generally defined as edges of the object.

Nominal tool point (NTP): used for implementing the process tolerance margin. The NTP is an oriented point defining a position and orientation. The NTP will be further detailed later in the description.

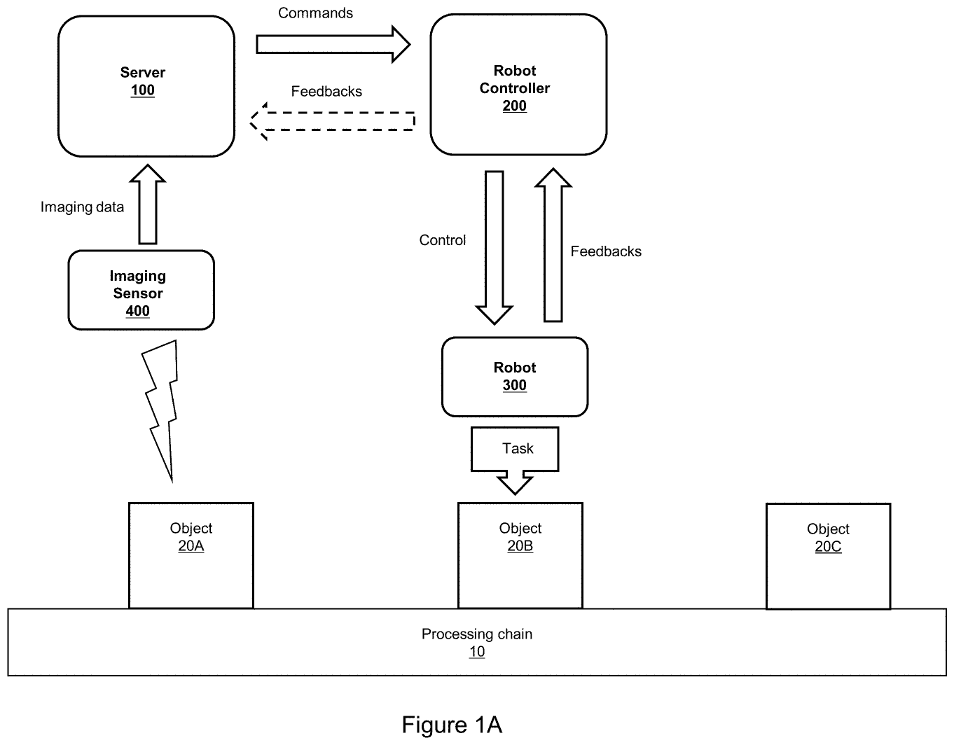

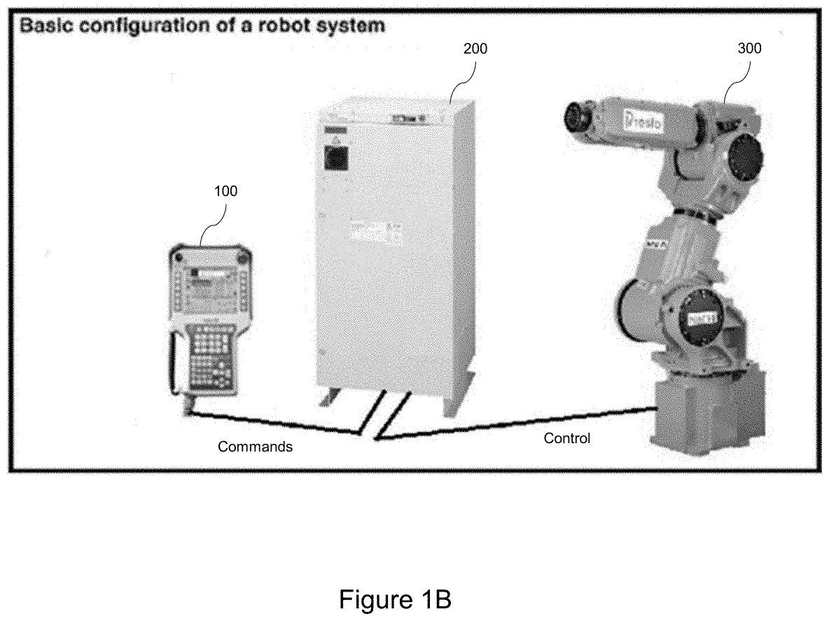

Referring now to FIG. 1A, a schematic representation of a processing chain 10 in a factory is illustrated. An object enters the processing chain 10, is processed by a robot 300 and exits the processing chain 10. FIG. 1A illustrates a first object 20A on the processing chain 10 not yet processed by the robot 300, a second object 20B on the processing chain 10 being currently processed by the robot 300, and a third object 20C on the processing chain 10 which has been processed by the robot 300.

Although not represented in FIG. 1A for simplification purposes, each object may be pre-processed before processing by the robot 300 and/or post-processed after processing by the robot 300. For example, the object 20A has just been processed by another robot (not represented in FIG. 1A) positioned downstream of robot 300 on the processing chain 10. Alternatively or complementarily, the object 20C is about to be processed by another robot (not represented in FIG. 1A) positioned upstream of robot 300 on the processing chain 10. Thus, the processing chain 10 may include one or more robot similar to the robot 300 represented in FIG. 1A, each robot being responsible for performing a given task on the objects (e.g. 20A, 20B and 20C) carried by the processing chain 10. The present disclosure focuses on the operations of the robot 300. If the processing chain 10 comprises additional robot(s), the additional robot(s) may operate in a manner similar to robot 300 or in a different manner.

As mentioned previously, the robot 300 operates in a factory. The term factory should be interpreted largely, to include any location where an industrial process involving industrial robots is performed. Examples of such factories include factories dedicated to the aeronautical industry, to the consumer goods industry (e.g. the automotive industry or the furniture industry), etc. In this context, the robot 300 performs an industrial process (for example, one of the following tasks: surface treatments (e.g. painting or coating), welding, material removal, etc.). However, the present disclosure is also applicable to any type of robot 300 capable of operating in a manner described in the rest of the description.

The robot 300 is controlled by a robot controller 200, which receives commands for controlling the robot 300 from a server 100. The server 100 is a computing device capable of executing one or more control software for controlling the robot 300. The control software generates commands transmitted to the robot controller 200 for controlling the tasks performed by the robot 300 on the object 20B. For example, the robot 300 comprises an articulated arm terminated by a tool and the commands comprise coordinates of joints of the articulated arm. The commands received from the server 100 are processed by the robot controller 200 to generate electrical control currents for actuating motor(s) of the articulated arm (to control the position of the articulated arm with respect to the object 20B). By controlling the position of the articulated arm with respect to the object 20B, the position and orientation of the tool (terminating the articulated arm) with respect to the object 20B is also controlled. The succession of positions of the articulated arm defines a trajectory of the articulated arm with respect to the object 20B. The trajectory (determined by the server 100 and enforced via the commands sent to the robot controller 200) allows the tool to perform a task on the object 20B (e.g. painting, welding, coating, etc.).

An imaging sensor 400 is also represented in FIG. 1A. The imaging sensor 400 generates imaging data of the object 20A, which are transmitted to the server 100. The server 100 processes the imaging data, to generate a geometric model of the object 20A. In the context of the present disclosure, the geometric model is a three-dimensional (3D) model of the object 20A. Alternatively, a 3D model of the object 20A generated by a computer-aided design (CAD) tool is directly transmitted to the server 100 (in this case, the imaging sensor 400 is not used). For illustration purposes only, the rest of the description will be based on the usage of one or more imaging sensor 400.

A single imaging sensor 400 is illustrated in FIG. 1A. In another configuration, a plurality of imaging sensors 400 operate in parallel, respectively generating imaging data of the object 20A. The imaging data generated by the plurality of imaging sensors 400 are transmitted to the server 100. The imaging data received from the plurality of imaging sensors 400 are combined by the server 100, to generate the 3D model of the object 20A.

The one or more imaging sensor 400 includes at least one of the following: a 2D camera (e.g. a standard Red Green Blue (RGB) camera), a 3D camera (e.g. a stereo camera), a depth sensor (e.g. an infrared, Time of Flight or laser sensor), a combination thereof, etc. The 3D model of the object 20A is generated based on one of the following: imaging data transmitted by a 3D camera, the combination of imaging data transmitted by two 2D cameras, the combination of imaging data transmitted by a 2D camera and a depth sensor, etc.

In an alternative implementation, the imaging data generated by the imaging sensor(s) 400 are transmitted to an intermediate computing device (not represented in FIG. 1A) in charge of generating the 3D model of the object 20A based on the imaging data. The intermediate computing device transmits the completed 3D model of the object 20A to the server 100.

Since the object 20A is carried by the processing chain 10, the object 20A is moving while the one or more imaging sensor 400 is generating the corresponding imaging data. Therefore, the one or more imaging sensor 400 is attached to a moving device (e.g. a robotic arm) capable of moving around the object 20A, to generate imaging data covering a target area of the object 20A (e.g. a surface of the object 20A or a portion of a surface of the object 20A, an edge of the object 20A, a summit of the object 20A, etc.). The target area of the object 20A needs to be processed by the robot 300 (e.g. painted, welded, coated, etc.). Although the target area of the object 20A may be of limited extension, a full 3D model of the object 20A is usually needed. The full 3D model of the object 20A allows the robot 300 to perform a task (e.g. painting, welding, coating, etc.) on the target area of the object 20A, taking into consideration constraints imposed by the shape and geometry of the object 20A to the movements of the robot 300 when performing the task.

The configuration illustrated in FIG. 1A allows a real time adaptation of the trajectory of the robot 300 to the objects carried by the processing chain 10. For example, when the one or more imaging sensor 400 has completed the task of generating all the imaging data used for the generation of the 3D model of the object 20A, it takes a time T for the object 20A to reach the current position of the object 20B. When the time T is elapsed, the robot 300 starts the processing of the object 20A. During the time T, the server 100 generates the 3D model of the object 20A based on the imaging data transmitted by the one or more imaging sensor 400. During the time T, the server 100 further calculates the trajectory of the robot 300 for performing a pre-defined task (e.g. painting, welding or coating) on the object 20A. The calculation of the trajectory depends on the 3D model of the object 20A, the pre-defined task to be performed, and additional parameters which will be detailed later in the description.

The server 100 does not use a pre-defined trajectory of the robot 300 for processing the object 20A, the pre-defined trajectory being determined in advance based on pre-defined geometric characteristics of the object 20A. The server 100 calculates a trajectory of the robot 300 for processing the object 20A in real-time. The calculated trajectory takes into consideration specific geometric characteristics of the object 20A, determined in real time based on the imaging data transmitted by the imaging sensor(s) 400. Thus, the robot 300 is capable of performing the same task (e.g. painting, welding or coating) on objects carried by the processing chain 10, where the objects may have different geometric characteristics. For example, the task is painting and the objects 20B and 20C are chairs of similar or different geometric characteristics, while the object 20A is a table.

Referring now concurrently to FIGS. 1A and 1B, FIG. 1B illustrates a basic configuration of a real-world robot system comprising the components (server 100, robot controller 200 and robot 300) schematically represented in FIG. 1A.

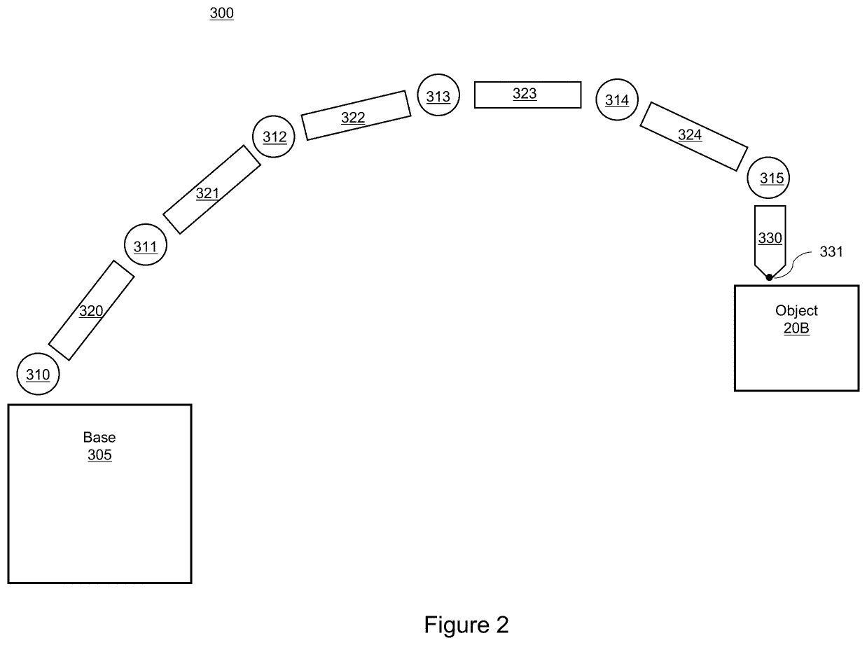

Reference is now made concurrently to FIGS. 1A and 2, where FIG. 2 provides a schematic representation of the robot 300 of FIG. 1A.

The robot 300 comprises a base 305 and an articulated arm. The articulated arm comprises a first end connected to the base 305, a plurality of N consecutive actuated joints (N being an integer), a corresponding plurality of N−1 links, and a second end adapted for securing a tool 330. Two consecutive actuated joints are connected by a link.

FIG. 2 illustrates an articulated arm with six consecutive actuated joints 310, 311, 312, 313, 314 and 315. Actuated joints 310 and 311 are connected by link 320, actuated joints 311 and 312 are connected by link 321, actuated joints 312 and 313 are connected by link 322, actuated joints 313 and 314 are connected by link 323, and actuated joints 314 and 315 are connected by link 324. However, the articulated arm may include any number of actuated joints greater or equal than one. For example, some robots have an articulated arm with seven consecutive actuated joints.

Each actuated joint is independently actuated by one or more motor (not represented in the Figures for simplification purposes). Each actuated joint is capable of a rotational movement around an axis or a translational movement along an axis (in some rare cases, a combination of a rotational and translational movement is performed by a single actuated joint, e.g. in the case of a powered screw). In the rest of the description, a position of a given actuated joint defined by the rotational movement around an axis or the translational movement along an axis will be referred to as the joint position of the given actuated joint.

In the configuration illustrated in FIG. 2, the first actuated joint 310 in the chain of consecutive actuated joints is represented as directly connected to the base 305. However, in another configuration, a first end of the articulated arm connects the first actuated joint 310 to the base 305. The first end consists of one or more mechanical component, such as a link, etc. (not represented in the Figures for simplification purposes).

A tool 330 is secured to the articulated arm. In the configuration illustrated in FIG. 2, the tool 330 is represented as directly secured to the last actuated joint 315 in the chain of consecutive actuated joints. However, in another configuration, a second end of the articulated arm connects the last actuated joint 315 to the tool 330. The second end consists of one or more mechanical component, such as a link, etc. (not represented in the Figures for simplification purposes).

The tool 330 comprises a tool center point (TCP) 331. The notion of TCP is well known in the art of robotics. When the articulated arm of the robot 300 moves, the TCP 331 follows a trajectory referred to as the toolpath. The toolpath comprises the consecutive positions and orientations of the TCP 331 allowing the robot 300 to perform a task on the object 20B. For example, in the case where the task is welding, the TCP 331 defines the point from which the electrical arc of the welding process is generated. In another example, in the case where the task is painting, the TCP 331 defines the point from which paint is sprayed on the object 20B, typically some distance away from the tool nozzle.

Alternatively, a virtual TCP not located on the tool 330 is used. The virtual TCP is a point of interest for performing the task on the object. The trajectory of the virtual TCP is also referred to as the toolpath. In the rest of the description, the terminology operation center point (OCP) will refer to a TCP or a virtual TCP.

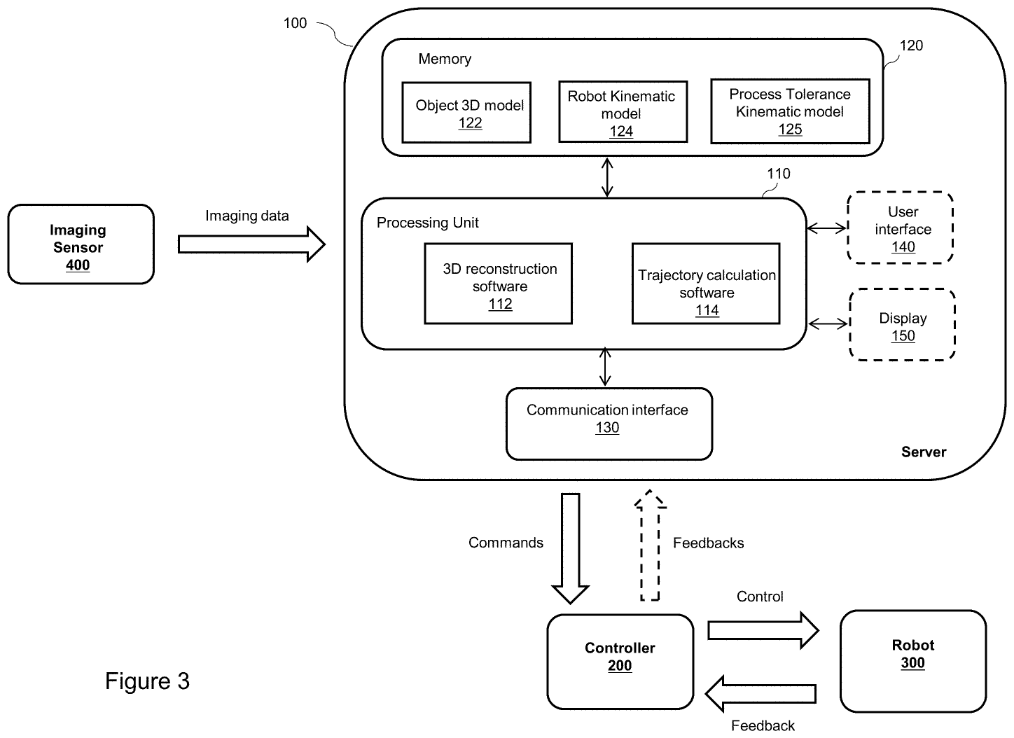

Reference is now made concurrently to FIGS. 1A and 3; where FIG. 3 represents details of the of the server 100 of FIG. 1A.

The server 100 comprises a processing unit 110, memory 120, a communication interface 130, optionally a user interface 140, and optionally a display 150. The server 100 may comprise additional components not represented in FIG. 3 for simplification purposes (e.g. an additional communication interface 130). The server 100 is generally a computing device with significant processing power and memory capacity.

The processing unit 110 comprises one or more processor (not represented in FIG. 3) capable of executing instructions of a computer program. Each processor may further comprise one or several cores. The processing unit 110 may comprise other types of components (e.g. graphics processing unit(s) (GPU), FPGA(s), ASIC(s), etc.), optimized to perform a specific task, for example 3D reconstruction or intensive calculations.

The memory 120 stores instructions of computer program(s) executed by the processing unit 110, data generated by the execution of the computer program(s), data received via the communication interface 130, etc. Only a single memory 120 is represented in FIG. 3, but the server 100 may comprise several types of memories, including volatile memory (such as a volatile Random Access Memory (RAM), etc.) and non-volatile memory (such as a hard drive, solid-state drive (SSD), electrically-erasable programmable read-only memory (EEPROM), flash, etc.).

The communication interface 130 allows the server 100 to exchange data with several devices (one or more imaging sensor 400, the robot controller 200, a remote control device sending instructions to the server 100, etc.) over one or more communication network (not represented in FIG. 3 for simplification purposes). The term communication interface 130 shall be interpreted broadly, as supporting a single communication standard/technology, or a plurality of communication standards/technologies. Examples of communication interfaces 130 include a wireless (e.g. Wi-Fi, cellular, wireless mesh, etc.) communication module, a wired (e.g. Ethernet) communication module, a combination of wireless and wired communication modules, etc. In an exemplary configuration, the communication interface 130 of the server 100 has a first wireless (e.g. Wi-Fi) communication module for exchanging data with the imaging sensor(s) 400 and the robot controller 200, and a second wired (e.g. Ethernet) communication module for exchanging data with one or more remote control device (not represented in FIG. 3 for simplification purposes). The communication interface 130 usually comprises a combination of hardware and software executed by the hardware, for implementing the communication functionalities of the communication interface 130.

As illustrated in FIG. 3, the memory 120 stores 3D model(s) (e.g. 122) and kinematic model(s) (e.g. robot kinematic model 124 and process tolerance kinematic model 125), while the processing unit 110 executes 3D reconstruction software(s) 112 and trajectory calculation software(s) 114. In the rest of the description, we will refer generically to a 3D reconstruction software 112 and a trajectory calculation software 114. However, a person skilled in the art would readily understand that a single 3D reconstruction software may include a plurality of software modules used synchronously or in parallel to implement 3D reconstruction functionalities. Similarly, a person skilled in the art would readily understand that a single trajectory calculation software may include a plurality of software modules used synchronously or in parallel to implement trajectory calculation functionalities.

A detailed representation of the components of the robot controller 200 is not provided in FIG. 3 for simplification purposes. In a standard implementation well known in the art of robotics, the robot controller 200 comprises at least one communication interface for receiving the commands from the server 100. The commands have been described previously. The communication interface may be of the wireline type (e.g. Ethernet, etc.) or the wireless type (e.g. Wi-Fi, Bluetooth, Bluetooth Low Energy (BLE), cellular, etc.).

The robot controller 200 also comprises a processing unit, the processing unit comprising one or more component. Examples of components of the processing unit include at least one of the following: processor(s), field-programmable gate array(s) (FPGA), application-specific integrated circuit(s) (ASIC), a combination thereof, etc. The processing unit processes the commands received from the server 100, to control the generation of the electrical control currents used for actuating the motor(s) of the articulated arm of the robot 300.

The robot controller 200 also comprises at least one power supply for powering the motor(s) of the articulated arm of the robot 300. For example, the processing unit of the robot controller 200 processes the commands received from the server 100 to modulate the electrical control currents generated by the at least one power supply. The modulation of the electrical control currents implements the motion control of the motor(s) associated to the actuated joint(s) of the articulated arm of the robot 300. As mentioned previously, the movement of each actuated joint is independent of the other actuated joints. The robot controller 200 is electrically connected to the robot 300 (e.g. to the base 305 of the robot 300 illustrated in FIG. 2), to transmit the electrical control currents.

The robot 300 transmits feedbacks to the robot controller 200, and optionally the robot controller 200 forwards at least some of the feedbacks to the server 100. An example of feedback is a joint position of the actuated joint(s) of the articulated arm of the robot 300, measured by one or more joint sensor associated to each actuated joint. The joint sensor(s) are adapted for measuring a joint position of the corresponding actuated joint. The feedbacks are used by the robot controller 200 to ensure that the effective position of the articulated arm of the robot 300 is compliant with the commands received from the server 100.

The foregoing description of the components of the robot controller 200 is for illustration purposes only. A person skilled in the art of robotics would readily understand that other implementations are applicable to the present disclosure. For example, the components of the robot controller 200 may be directly integrated to the robot 300 (e.g. in the base 305 of the robot 300 illustrated in FIG. 2).

Reference is now made to the objects 20A, 20B and 20C represented in FIG. 1A. The 3D reconstruction software 112 has generated a 3D model 122 for object 20C, which has been used by the trajectory calculation software 114 to generate a trajectory for controlling the articulated arm of the robot 300 during the processing of object 20C (now completed). The 3D reconstruction software 112 has generated another 3D model 122 for object 20B, which has been used by the trajectory calculation software 114 to generate a trajectory for controlling the articulated arm of the robot 300 during the processing of object 20B (currently performed). The 3D reconstruction software 112 is currently generating still another 3D model 122 for object 20A, which will be used by the trajectory calculation software 114 to generate a trajectory for controlling the articulated arm of the robot 300 during the processing of object 20A (to be performed next). As mentioned previously, the 3D reconstruction software 112 uses the imaging data transmitted by the imaging sensor(s) 400 for respectively generating the 3D models of objects 20A, 20B and 20C.

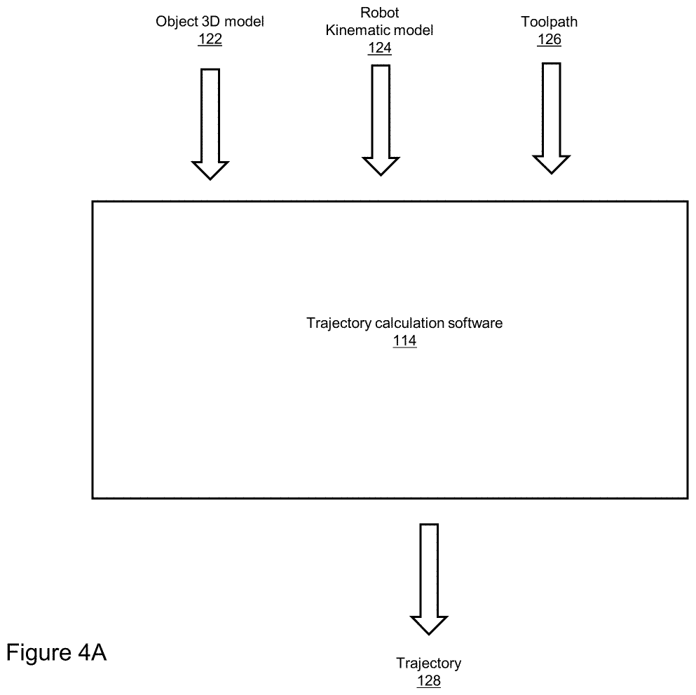

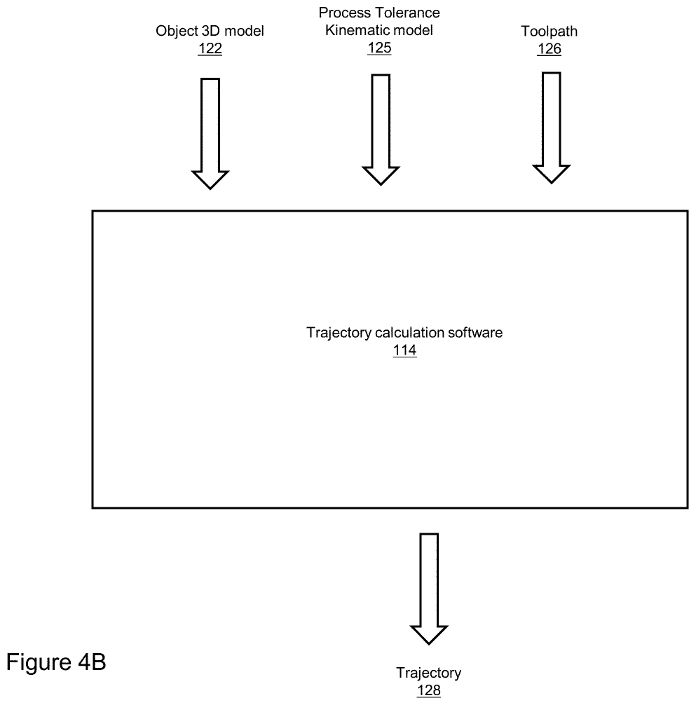

Reference is now made concurrently to FIGS. 1A, 2, 3 and 4A; where FIG. 4A represents a schematic implementation of the trajectory calculation software 114 represented in FIG. 3.

FIG. 4A illustrates an implementation, where the trajectory calculation software 114 uses inputs well known in the art of robotics to calculate a trajectory 128 of the articulated arm of the robot 300. The trajectory 128 defines a succession of positions of the articulated arm of the robot 300. Each position of the articulated arm includes the respective joint positions of the N consecutive actuated joints (e.g. 310, 311, 312, 313, 314, 315 as illustrated in FIG. 2) of the articulated arm.

As mentioned previously, the trajectory 128 is calculated dynamically for a given object (e.g. 20A). In the interval of time between the completion by the one or more imaging sensor 400 of the generation (and transmission) of the imaging data of the given object and the beginning of the task performed by the robot 300 on the given object, the 3D model 122 of the given object and the trajectory 128 of the articulated arm for the given object are calculated (respectively by the 3D reconstruction software 112 and the trajectory calculation software 114). The beginning of the task performed by the robot 300 on the given object occurs when the processing chain 10 carries the given object at a given position with respect to the robot 300.

Having the trajectory 128 of the articulated arm of the robot 300, the processing unit 110 generates a sequence of commands transmitted to the robot controller 200 (via the communication interface 130) for controlling the articulated arm of the robot 300. As mentioned previously, the robot controller 200 generates electrical control currents based on the received sequence of commands, to actuate the motors respectively controlling the N consecutive actuated joints of the articulated arm of the robot 300.

For example, a command actuates a motor to perform a rotation of an actuated joint from its current joint position to a next joint position. The next joint position becomes the current joint position for the next command. For instance, a first command is defined by an angle A1 (in degrees) and optionally a rotation speed S (in turns or degrees per second), the following command is defined by an angle A2 (in degrees) and optionally a rotation speed S2 (in turns or degrees per second), etc. The rotational command also includes a direction (e.g. clockwise or counterclockwise).

In another example, a command actuates a motor to perform a translation of an actuated joint from its current joint position to a next joint position. The next joint position becomes the current joint position for the next command. For instance, a first command is defined by a translation T1 (in millimeters) and optionally a translation speed S1 (in millimeters per second), the following command is defined by a translation T2 (in millimeters) and optionally a translation speed S2 (in millimeters per second), etc. The translational command also includes a direction (e.g. forward or backward).

A particular use case consists of a succession of similar objects, on which the same task is performed by the robot 300, being carried by the processing chain 10. Even in this case, a 3D model 122 and a corresponding trajectory 128 of the articulated arm of the robot 300 is calculated for each object, to take into consideration potential minor differences in the geometric characteristics of each object and potential minor differences in the position of each object on the processing chain 10.

The input parameters of the trajectory calculation software 114 include the 3D model 122 of the object, the robot kinematic model 124 of the articulated arm of the robot 300 and a toolpath 126. Additional input parameters (not represented in FIG. 4A for simplification purposes) may be used to take into account the position of the robot 300 with respect to the processing chain 10, a speed of translation of the processing chain 10, etc.

The input parameter consisting of the 3D model 122 of the object has been described previously. Taking into consideration the 3D model 122 of the object in the calculation of the trajectory 128 of the articulated arm of the robot 300 prevents collisions between the object being processed by the robot 300 and the articulated arm of the robot 300 (or the tool 330 secured to the articulated arm of the robot 300).

The input parameter consisting of the robot kinematic model 124 is well known in the art. The robot kinematic model 124 comprises a plurality of active joints in series respectively corresponding to the plurality of actuated joints of the articulated arm of the robot 300. The active joints are virtual representations of the actuated joints. For example, referring to FIG. 2, the robot kinematic model 124 comprises six active joints respectively corresponding to the actuated joints 310, 311, 312, 313, 314 and 315. The kinematic model further defines a position and orientation of the OCP 331. The position and orientation of the OCP 331 is usually defined with respect to the last active joint (e.g. 315) of the series of active joints.

For simplification purposes, in the rest of the description, the same reference number will be used when referring to an actuated joint and the corresponding active joint. The terminology actuated and active provides for differentiating between the actuated joint (being physically part of the articulated arm of the robot 300) and the corresponding active joint (being a virtual representation of the actuated arm in the robot kinematic model 124).

The robot kinematic model 124 takes into consideration the characteristics of the actuated joints (e.g. 310 to 315), the characteristics of the links (e.g. 320 to 324) between the actuated joints, and the characteristics of the tool 330 to define a mathematical model. The mathematical model correlates the respective joint positions of the active joints (e.g. 310 to 315) and the position and orientation of the OCP 331. For example, a kinematic model well known in the art consists of the Denavit-Hartenberg (DH) model.

Examples of characteristics of the actuated joints taken into consideration by the robot kinematic model 124 include: a type of joint (rotational or translational), geometric characteristics of the actuated joints (e.g. dimensions, geometric shape, etc.), optionally boundaries to a joint position of the actuated joint (e.g. a maximum and/or minimum angle of rotation; or a maximum and/or minimum linear displacement), etc. Examples of characteristics of the links between the actuated joints taken into consideration by the robot kinematic model 124 include: geometric characteristics of the links (e.g. dimensions, geometric shape, etc.), etc. Examples of characteristics of the tool 330 taken into consideration by the robot kinematic model 124 include: geometric characteristics of the tool 330 (e.g. dimensions, geometric shape, etc.), position and orientation of the OCP 331 with respect to the tool 330, etc. Knowing the respective geometric characteristics of the actuated joints (e.g. 310 to 315), the links (e.g. 320 to 324) and the tool 330, the mathematical model correlating the respective joint positions of the active joints (e.g. 310 to 315) and the position and orientation of the OCP 331 is generated.

A first type of kinematic computation using the robot kinematic model 124 consists of a forward kinematic computation. Knowing a current joint position of all the joints (e.g. 310 to 315), the position and orientation of the OCP 331 is computed. As mentioned previously, a mathematical model (such as the DH model) is used to correlate a joint position of a given joint (e.g. translation along an axis for a translational joint or rotation around an axis for a rotational joint) with a position and orientation in a three dimensional space of the given joint considered as an oriented point. Referring to FIG. 2, a new position and orientation of active joint 311 is calculated, then a new position and orientation of active joint 312 is calculated, then a new position and orientation of active joint 313 is calculated, then a new position and orientation of active joint 314 is calculated, then a new position and orientation of active joint 315 is calculated, and finally a new position and orientation of the OCP 331 is calculated.

A second type of kinematic computation using the robot kinematic model 124 consists of a backward kinematic computation. Knowing a current position and orientation of the OCP 331, possible combinations of joint positions for each joint are computed. The backward kinematic computation is used to calculate the corresponding new joint positions of the joints for a given position and orientation of the OCP 331 using numerical methods (generally based on iterative optimization).

The input parameter consisting of the toolpath 126 is well known in the art. As mentioned previously, the toolpath comprises a plurality of positions and orientations of the OCP 331 for performing a task (e.g. painting, welding or coating) on the object processed by the robot 300. The toolpath is calculated by the processing unit 110 and generally stored in the memory 120.

The task is defined by a target area of the object upon which the task is performed. The target area consists of a surface of the object, a portion of the surface of the object (e.g. a plurality of points located on the surface of the object), an edge of the object, a summit of the object, etc. A complex target area may also be the combination of basic target areas (e.g. a combination of one or more surface and/or one or more portion of surface(s)). For example, the object comprises a component having the shape of a cube, and at least some of the faces of the cube are comprised in the target area of the object upon which the task is performed. In another example, the object comprises a cavity having the shape of a hollow cylinder, and at least a portion of an inner surface of the cylinder is comprised in the target area of the object upon which the task is performed.

The 3D model 122 of the object is processed, to identify the position of the target area in the 3D model 122 of the object. For this purpose, the target area is decomposed into primitive geometric shape(s) and a determination is made of the position of the primitive geometric shape(s) in the 3D model 122 of the object. Then, relative positions and orientations of the OCP 331 with respect to the 3D model 122 of the object are calculated, the relative positions and orientations of the OCP 331 constituting the toolpath allowing the tool 330 to perform the task on the target area of the object. The calculation of the toolpath is well known in the art of robotics and various algorithms known in the art can be used for performing the calculation.

One additional parameter taken into consideration by the trajectory calculation software 114 is a nominal position and orientation of the tool 330 with respect to the target area the object when the robot 300 performs the task on the object. This additional parameter is considered to be part of the robot kinematic model 124 and is therefore not represented in FIG. 4A. However, in another implementation, this additional parameter may be considered to be independent of the robot kinematic model 124.

For example, if the tool 330 has substantially an elongated shape (e.g. substantially a cylindrical shape), an exemplary nominal position and orientation of the tool 330 includes being orthogonal to a surface on the object being currently processed by the tool 330. More generally, the nominal position and orientation of the tool 330 depends on the geometric characteristics of the tool 330, the process characteristics, the task performed by the tool 330, etc.

For a given position and orientation of the OCP 331, taking into consideration the 3D model of the object and the nominal position and orientation of the tool 330 with respect to the object, the corresponding joint position of the last active joint (e.g. 315 in FIG. 2) in the chain of active joints (e.g. 310 to 315 in FIG. 2) is determined and unique.

Similarly, for a given joint position of the last active joint (e.g. 315 in FIG. 2) in the chain of active joints (e.g. 310 to 315 in FIG. 2), taking into consideration the 3D model of the object and the nominal position and orientation of the tool 330 with respect to the object, the corresponding joint position of the OCP 331 is determined and unique.

One implementation of the trajectory calculation software 114 uses a backward kinematic computation based on the robot kinematic model 124 to calculate the trajectory 128. Having a current position and orientation of the OCP 331 in the toolpath 126, the trajectory calculation software 114 explores a domain of candidate joint positions (e.g. 310 to 315) within a valid domain of solutions (e.g. a valid angular domain for a rotational joint and a valid translation domain for a translational joint) for the active joints (e.g. 310 to 315). If several solutions are available, other criteria are taken into consideration for selecting one among the several solutions (e.g. minimal movement of the active joints from their respective current to next joint positions). Furthermore, solution(s) where the transition from the current joint position of the active joints to the next joint position of the active joints involves a collision of the articulated arm of the robot 300 (or the tool 330) with the processed object are eliminated (using the 3D model 122 of the object for detecting the collisions). Once a solution is selected, the next joint positions of the active joints and the next position and orientation of the OCP 331 become the current ones, and a new iteration is performed for the next position and orientation of the OCP 331 defined by the toolpath 126. It may occur that for a next position and orientation of the OCP 331, no solution can be found. In this case, the algorithm reverts back to a previous iteration (corresponding to a previous position and orientation of the OCP 331 in the toolpath 126) where several solutions were available, selects a new solution, and proceeds forwards with the next iterations (corresponding to the following positions and orientations of the OCP 331 in the toolpath 126).

Different kind of algorithms can be used by the trajectory calculation software 114 for calculating the trajectory 128, including algorithms making use of artificial intelligence techniques. For example, hierarchical task network (HTN) planning, Monte Carlo Decision Tree, Deep Reinforcement Learning, a combination of some of those techniques, etc.

As mentioned previously, the toolpath 126 comprises relative positions and orientations of the OCP 331 with respect to the processed object. If the processed object is moving with respect to the robot 300, this movement is taken into consideration to calculate an absolute position and orientation of the OCP 331. The absolute position and orientation of the OCP 331 takes into consideration the relative position and orientation of the OCP 331 and the movement of the object. The absolute position and orientation is used in place of the relative position and orientation for calculating the trajectory 128. For example, referring to FIGS. 1A and 2, the object 20B currently processed by the robot 300 is carried by the processing chain 10 and is therefore in movement with respect to the base 305 of the robot 300 which is generally fixed.

The robot kinematic model 124 may take into consideration additional parameters of the actuated joints, such as a range of achievable speeds (e.g. rotational or linear speeds) and optionally a range of achievable accelerations (e.g. rotational or linear accelerations) for at least some of the actuated joints. If the toolpath 126 further defines constraints on the speed and/or acceleration of the OCP 331, the trajectory 128 also defines the speed and/or acceleration applied to each actuated joint when executing the trajectory.

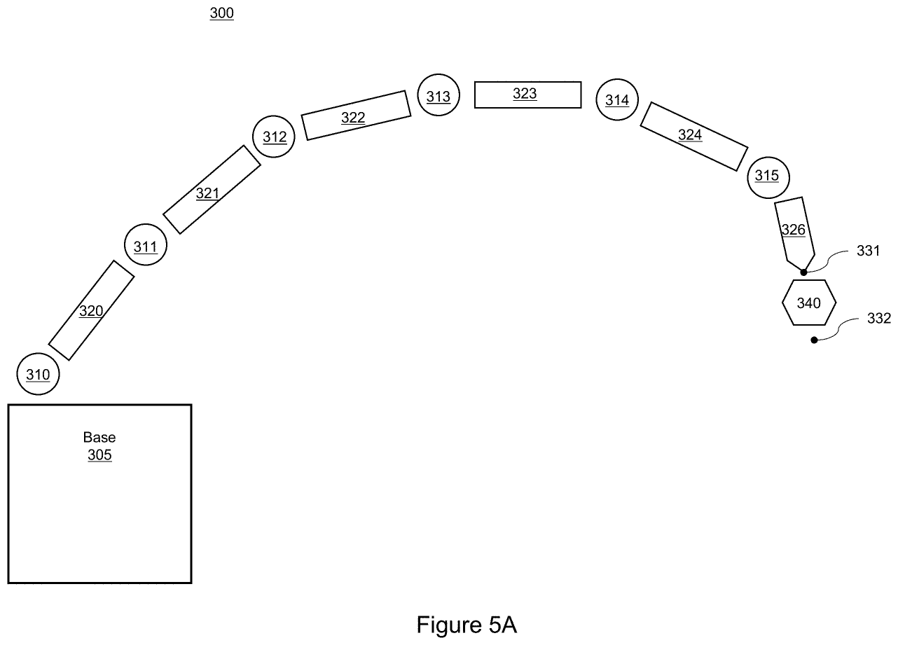

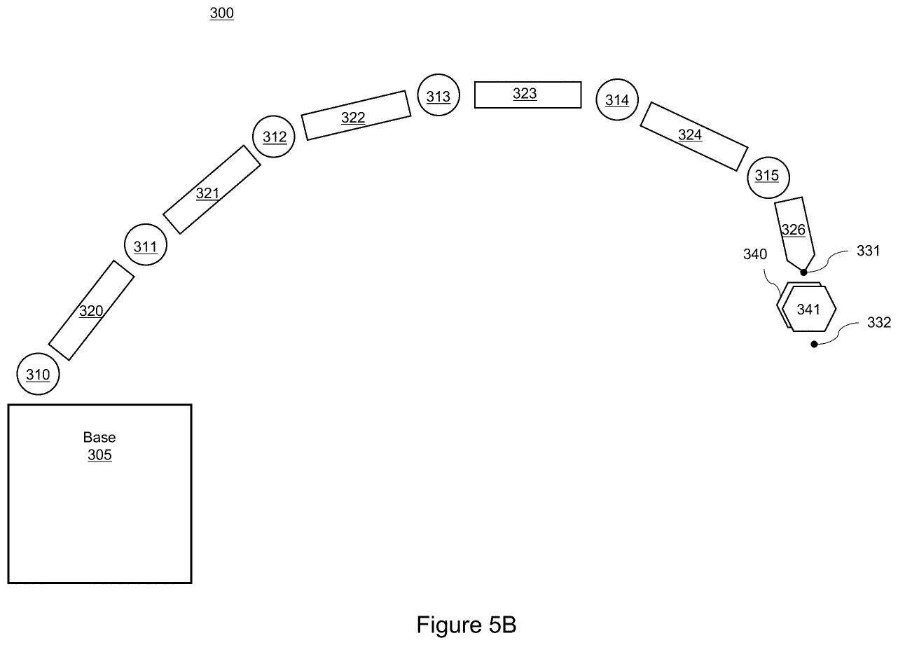

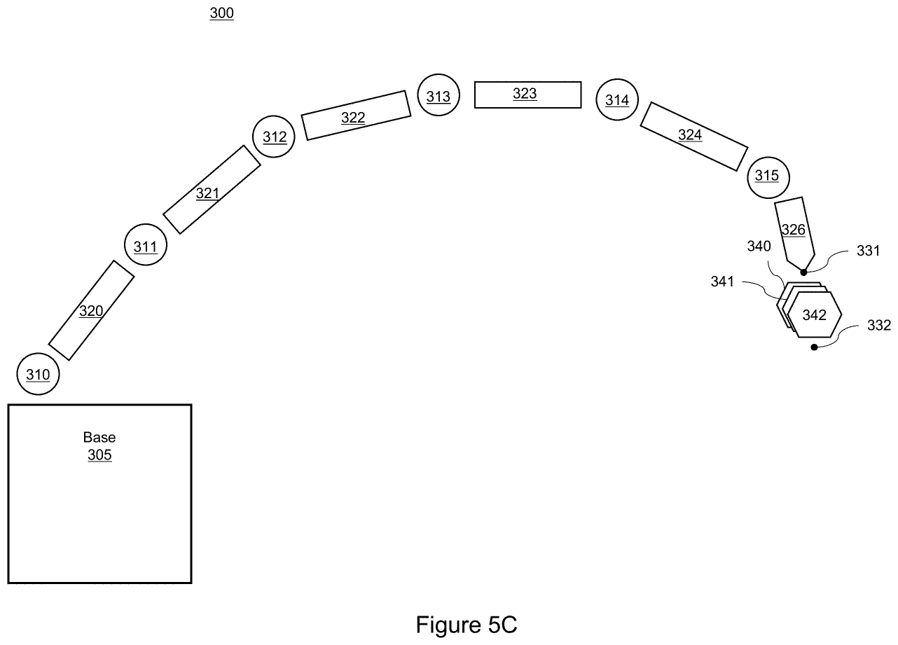

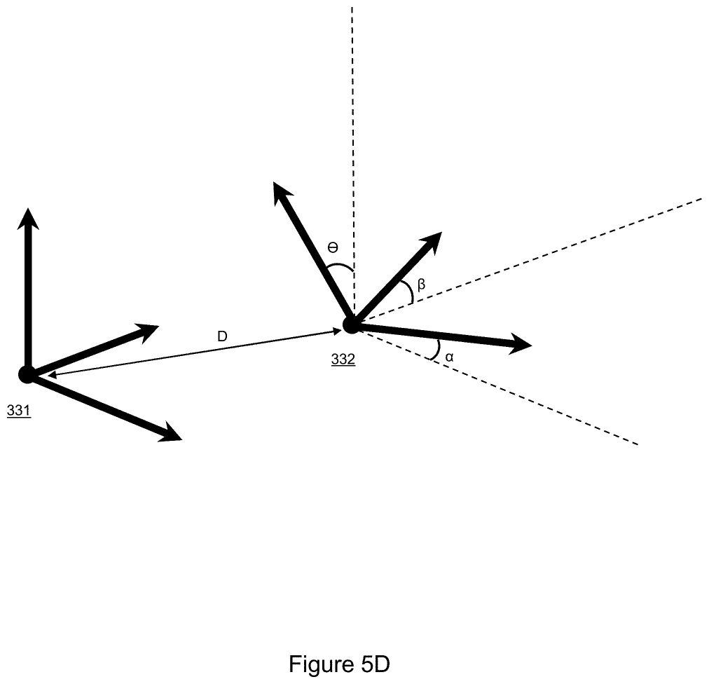

Reference is now made concurrently to FIGS. 2, 4B, 5A, 5B, 5C, 5D, 6A, 6B, 6C, 6D and 6E. A new implementation of the trajectory calculation software 114 uses a new kinematic model 125 illustrated in FIGS. 5A, 5B and 5C.

The new implementation of the trajectory calculation software 114 is illustrated in FIG. 4B. It is similar to the implementation previously described with reference to FIG. 4A, except for the new kinematic model 125 being used in place of the robot kinematic model 124 represented in FIG. 4A.

The new kinematic model 125 is referred to as the process tolerance kinematic model. The process tolerance kinematic model 125 comprises the previously described plurality of active joints in series, respectively corresponding to the plurality of actuated joints of the articulated arm of the robot 300. For example, the process tolerance kinematic model 125 comprises the six active joints respectively corresponding to the actuated joints 310, 311, 312, 313, 314 and 315.

The process tolerance kinematic model 125 further comprises at least one passive joint. The at least one passive joint simulates the process tolerance margin on a position and/or orientation of the tool 330 with respect to the object (e.g. 20B) when the tool 330 performs a task on the object (e.g. 20B).

The plurality of active joints and the at least one passive joint form a kinematic chain. FIG. 5A illustrates the kinematic chain comprising the six active joints 310-311-312-313-314-315 and a single passive joint 340.

FIG. 5B illustrates the kinematic chain comprising the six active joints 310-311-312-313-314-315 and two co-located passive joints 340-341.

FIG. 5C illustrates the kinematic chain comprising the six active joints 310-311-312-313-314-315 and three co-located passive joints 340-342.

Each passive joint 340, 341 and 342 illustrated in the FIGS. 5A, 5B and 5C may be a translational or a rotational joint. Another configuration not illustrated in the Figures comprises four co-located passive joints (for example, a combination of three rotational passive joints and one translational passive joint).

As mentioned previously, the process tolerance kinematic model 125 further defines the position and orientation of the OCP 331. The position and orientation of the OCP 331 is usually defined with respect to the last active joint (e.g. 315) of the series of active joints. The process tolerance kinematic model 125 defines a mathematical model correlating the respective joint positions of the plurality of active joints (e.g. 310 to 315), the at least one passive joint (e.g. 340 in FIG. 5A, 340-341 in FIG. 5B, 340-342 in FIG. 5C), and the position and orientation of the OCP 331.

As mentioned previously, the characteristics of the actuated joints (e.g. 310 to 315), the characteristics of the links (e.g. 320 to 324) between the actuated joints and the position and orientation of the OCP 331 with respect to the tool 330 are taken into consideration for generating the process tolerance kinematic model 125.

Examples of characteristics of the actuated joints taken into consideration by the process tolerance kinematic model 125 and examples of characteristics of the links between the actuated joints taken into consideration by the process tolerance kinematic model 125 have been detailed previously.

A Nominal tool point (NTP) 332 is also represented in FIGS. 5A, 5B and 5C. The NTP 332 defines a position and orientation of the process applied to the object being processed. The tolerance joints (e.g. 340 in FIG. 5A, 340-341 in FIG. 5B, 340-342 in FIG. 5C) define a distance between the OCP 331 and the NTP 332 and a difference of orientation between the OCP 331 and the NTP 332. As mentioned previously, the OCP 331 and NTP 332 are orientated points, FIG. 5D represents the OCP 331 and NTP 332 in a three dimensional space, illustrating the distance (D) and difference of orientation (angles α, β and Θ) of the NTP 332 with respect to the OCP 331.

The characteristics of the process tolerance margin are taken into consideration for defining the at least one passive joint in the process tolerance kinematic model 125. For each passive joint, a nominal joint position of the passive joint and a tolerance margin with respect to the nominal joint position of the passive joint are defined. The nominal joint position(s) and the tolerance margin(s) of the passive joint(s) simulate the process tolerance margin on the position and/or orientation of the tool with respect to the object when the tool performs a task on the object. More specifically, the nominal joint position of the one or more passive joint defines a nominal position and orientation of the tool 330 with respect to the object (e.g. 20B) when the tool 330 performs a task on the object (e.g. 20B). The tolerance margin of the one or more passive joint defines a tolerance margin on at least one of the nominal position and nominal orientation of the tool 330 with respect to the object (e.g. 20B) when the tool 330 performs the task on the object (e.g. 20B).

For example, the tool 330 has one degree of liberty from the nominal position and orientation of the tool 330 with respect to the processed object. The degree of liberty consists of a push/pull angle, an elevation angle or a translation. This use case is illustrated by FIG. 5A, where a single passive joint 340 is used. The tolerance margin associated to the passive joint 340 is a maximum and/or minimum angle of rotation (in the case of the push/pull or elevation angle); or a maximum and/or minimum linear displacement (in the case of the translation).

In another example, the tool 330 has two degrees of liberty from the nominal position and orientation of the tool 330 with respect to the processed object. The two degrees of liberty consist of a combination of at least two of: a push/pull angle, an elevation angle and a translation. This use case is illustrated by FIG. 5B, where two co-located passive joints 340 and 341 are used. As mentioned previously, the tolerance margin associated to the passive joints 340 and 341 is a maximum and/or minimum angle of rotation; or a maximum and/or minimum linear displacement.

In still another example, the tool 330 has three degrees of liberty from the nominal position and orientation of the tool 330 with respect to the processed object. The three degrees of liberty consist of a combination of: a push/pull angle, an elevation angle and a translation. This use case is illustrated by FIG. 5C, where three co-located passive joints 340, 341 and 342 are used. As mentioned previously, the tolerance margin associated to the passive joints 340, 341 and 342 is a maximum and/or minimum angle of rotation; or a maximum and/or minimum linear displacement.

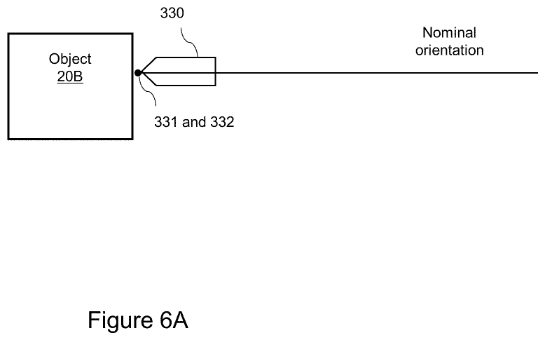

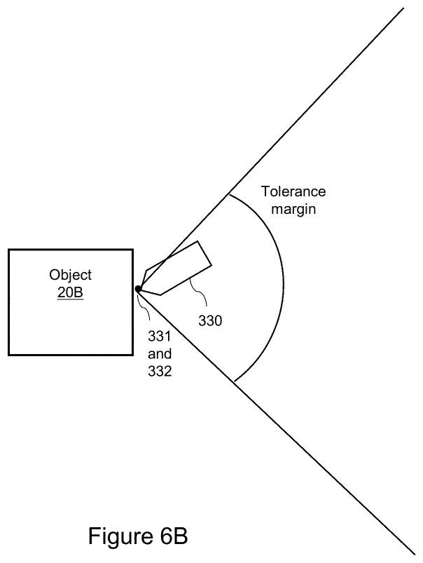

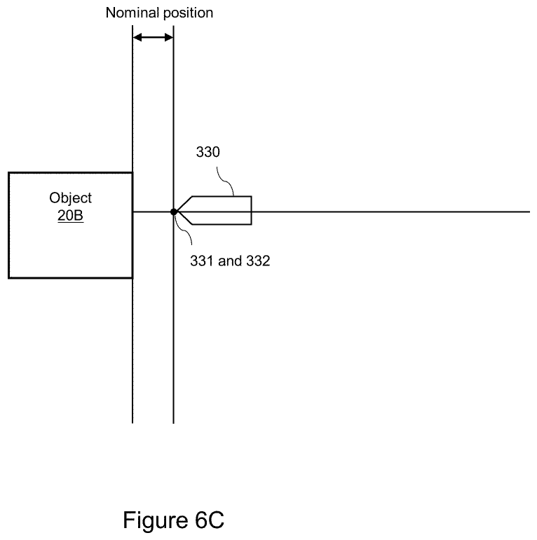

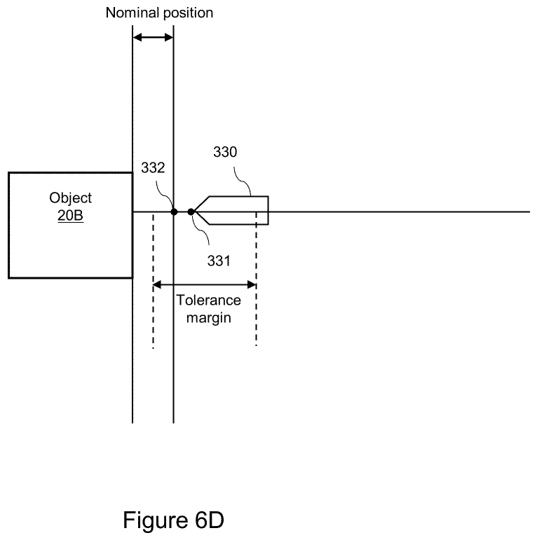

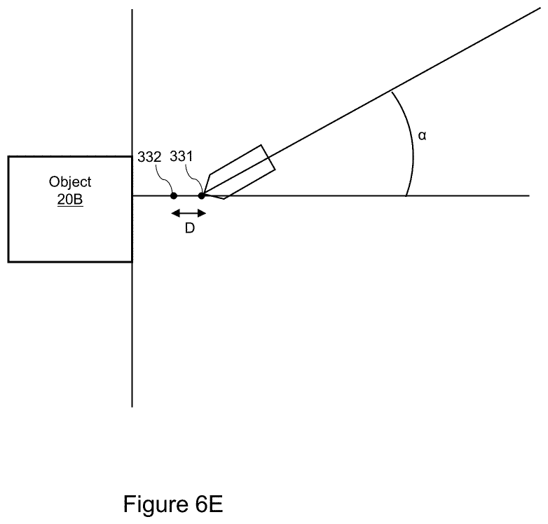

FIG. 6A illustrates a nominal orientation of the tool 330 with respect to the object 20B defining a corresponding nominal orientation of the OCP 331. For example, as illustrated in FIG. 6A, the nominal orientation of the tool 330 consists in being substantially orthogonal (angle of 90 degrees) to a target area of the object 20B being processed by the tool 330. The OCP 331 and NTP 332 are identical in FIG. 6A. FIG. 6B illustrates a tolerance margin on the orientation of the tool 330 with respect to the object 20B. For simplification purposes, FIG. 6B illustrates a tolerance margin on the orientation in a single dimension. The OCP 331 and NTP 332 are co-located but have a different orientation. For the example illustrated in FIG. 6B, the tolerance margin is defined by a minimum angle of 40 degrees and a maximum angle of 140 degrees. The tolerance margin on the orientation of the tool 330 allows any orientation of the tool 330 between 40 and 140 degrees (including the nominal angle of 90 degrees illustrated in FIG. 6A). The tolerance margin on the orientation of the tool 330 is simulated in the process tolerance kinematic model 125 by a rotational passive joint (e.g. 340) characterized by a nominal joint position (corresponding to the nominal angle of the tool 330 represented in FIG. 6A), and a tolerance margin with respect to the nominal joint position of the passive joint (corresponding to the minimum and maximum angles of the tool 330 represented in FIG. 6B). The nominal joint position of the rotational passive joint is 90 degrees, and the tolerance margin of the rotational passive joint is a minimum angle of 40 degrees and a maximum angle of 140 degrees.

FIG. 6C illustrates a nominal position of the tool 330 with respect to the object 20B defining a corresponding nominal position of the OCP 331. For example, as illustrated in FIG. 6C, the nominal position of the tool 330 consists in being at a distance of substantially 5 millimeters from a target area of the object 20B being processed by the tool 330. The OCP 331 and NTP 332 are identical in FIG. 6C. FIG. 6D illustrates a tolerance margin on the position of the tool 330 with respect to the object 20B. The OCP 331 and NTP 332 are at a distance of one another. For example, as illustrated in FIG. 6D, the tolerance margin is defined by a minimum distance of 3 millimeters and a maximum distance of 10 millimeters. The tolerance margin on the position of the tool 330 allows any position of the tool 330 between 3 and 10 millimeters (including the nominal position of 5 millimeters illustrated in FIG. 6C). The tolerance margin on the position of the tool 330 is simulated in the process tolerance kinematic model 125 by a translational passive joint (e.g. 341) characterized by a nominal joint position (corresponding to the nominal distance of the tool 330 represented in FIG. 6C), and a tolerance margin with respect to the nominal joint position of the passive joint (corresponding to the minimum and maximum distances of the tool 330 represented in FIG. 6D). The nominal joint position of the translational passive joint is 5 millimeters, and the tolerance margin of the translational passive joint is a minimum distance of 3 millimeters and a maximum distance of 10 millimeters.

As mentioned previously, the rotational passive joint (e.g. 340) corresponding to FIGS. 6A-B and the translational passive joint (e.g. 341) corresponding to FIGS. 6C-D can be combined in the process tolerance kinematic model 125 to simulate two degrees of liberty of the tool 330 with respect to the object 20B.

FIG. 6E is a combination of FIGS. 6B and 6D illustrating a tolerance margin on a position (distance D) and orientation (angle α in a single dimension for simplification purposes) of the tool 330 with respect to the object 20B. A corresponding representation in a three dimensional space is provided in FIG. 5D, which illustrates the distance (D) and difference of orientation (angles α, β and Θ) of the NTP 332 with respect to the OCP 331, representative of the tolerance margin on a position and orientation (in the three dimensional space) of the tool 330 with respect to the object 20B. A combination of one translational passive joint and three rotational passive joints can be used to represent the four degrees of liberty (distance D and angles α, β and Θ).

The previously mentioned backward kinematic computation can be applied using the process tolerance kinematic model 125. Knowing a current position and orientation of the OCP 331, the use of active joints and passive joints (simulating the process tolerance margin) vastly increases the solution domain, therefore increasing the possibility of finding a valid set of joint positions for which collision, active joint limits or singularities are avoided.

The previously described implementation of the trajectory calculation software 114 (illustrated in FIG. 4A) is applicable to the process tolerance kinematic model 125, which includes the one or more passive joints in addition to the active joints. The series of N consecutive active joints (e.g. 310 to 315) and M co-located passive joint(s) (e.g. 340 to 342) are processed by the calculation software 114 as if it virtually consisted of a series of N+M joints, where the M virtual active joint(s) correspond to the M passive joint(s) of the process tolerance kinematic model 125. As illustrated in FIG. 4B, the inputs of the trajectory calculation software 114 comprise the 3D model of the object 122, the process tolerance kinematic model 125 and the toolpath 126.

The toolpath 126 comprises a plurality of positions and orientations of the NTP 332. As mentioned previously, each position and orientation of the NTP 332 corresponds to a position and orientation of the OCP 331 where the joint position of each passive joint is the nominal joint position of the passive joint.

During the processing by the calculation software 114, the tolerance margin in the joint position of each one of the M passive joint(s) with respect to its nominal joint position is taken into consideration. As mentioned previously, one implementation of the trajectory calculation software 114 uses a backward kinematic computation, to find a kinematic solution to the toolpath 126. By adding the passive joints to the kinematic chain, the solution domain is increased, which in turn increases the possibility of finding a solution.

As mentioned previously, constraints on the joint position of some of the active joints may also be defined (corresponding to constraints on the rotational or translational movements of the corresponding actuated joints of the articulated arm of the robot 300), and are also taken into consideration by the calculation software 114. Thus, constraints on the joint positions of the active joints may or may not be present, while constraints on the joint positions of the passive joints are always present (in the form, for each passive joint, of the nominal joint position and the tolerance margin with respect to the nominal joint position).

Optionally, a cost function is defined for each passive joint. The cost function allocates a cost value for each valid joint position of the passive joint. A valid joint position of a passive joint is defined as a joint position within the tolerance margin with respect to the nominal joint position of the passive joint. The calculation of the trajectory 128 further takes into consideration the cost function of each of the at least one passive joint. The cost allocated by the cost function is minimum at the nominal joint position. The cost allocated by the cost function to a valid joint position increases in accordance with a distance between the valid joint position and the nominal joint position. For example, the nominal joint position is an angle of 90 degrees and the tolerance margin is an angle from 40 to 140 degrees. The cost at 90 degrees is 0, the cost at 65 or 115 degrees is 0.5, the cost at 40 or 140 degrees is 1. This implementation of the cost function favors a joint position closer to the nominal joint position while allowing a joint position different from the nominal joint position when the nominal position is not achievable.

For a given position and orientation of the NTP 332, if several sets of joint positions are candidate for the trajectory 128, the candidate set of joint positions for which the passive joints have the lower value of the cost function is selected. Alternatively, if several passive joints are defined in the process tolerance kinematic model 125, for a given position and orientation of the NTP 332, the cost functions of all the passive joints are taken into consideration simultaneously for selecting a joint position of the passive joints among candidate joint positions of the passive joints. For example, the sum of the values of the cost functions is calculated for each set of candidate joint positions of the passive joints, and the candidate joint positions of the passive joints with the lowest sum is selected. Alternatively, the value of the cost function(s) is optimized for a plurality of consecutive positions and orientations of the NTP 332 taken into consideration simultaneously.

An exemplary implementation of the cost function consists in simulating the action of a spring being at rest at the nominal joint position of the passive joint (e.g. the angle of 90 degrees in the previous example) and being at a maximum extension when the passive joint reaches the joint position(s) corresponding to the limit(s) of the tolerance margin of the passive joint (e.g. the angles of 40 and 140 degrees in the previous example).

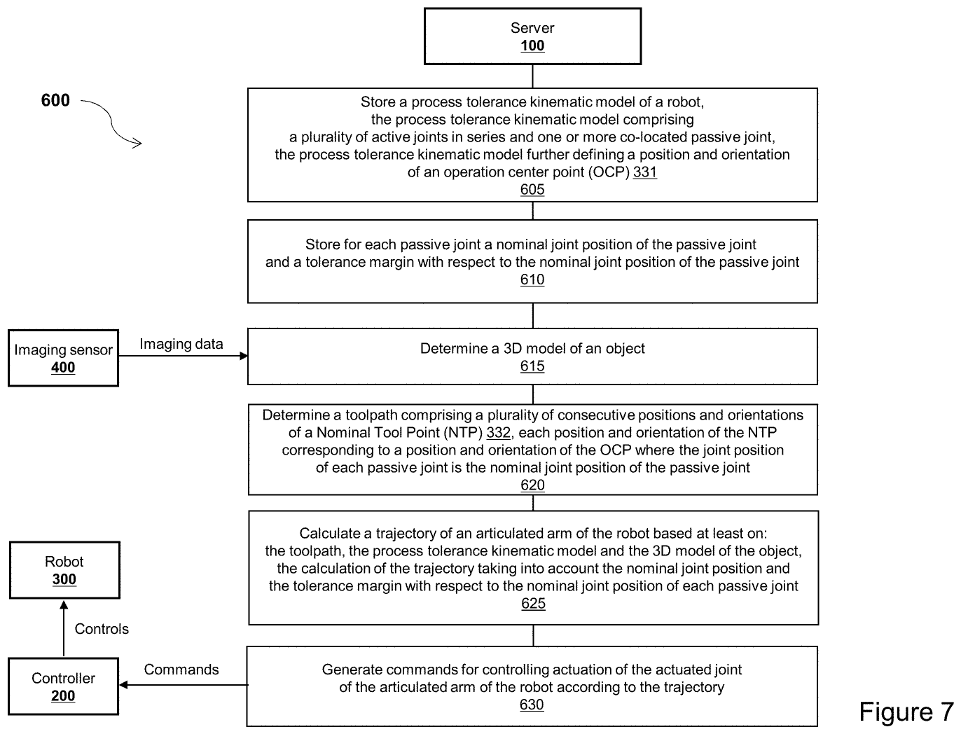

Reference is now made concurrently to FIGS. 2, 3, 4B, 5A-D and 7, where FIG. 7 represents a method 600 for calculating a trajectory of the articulated arm of the robot 300. At least some of the steps of the method 600 are implemented by the server 100.

A dedicated computer program has instructions for implementing at least some of the steps of the method 600. The instructions are comprised in a non-transitory computer program product (e.g. the memory 120) of the server 100. The instructions, when executed by the processing unit 110 of the server 100, provide for calculating a trajectory of the articulated arm of the robot 300. The instructions are deliverable to the server 100 via an electronically-readable media such as a storage media (e.g. CD-ROM, or any internally or externally attached storage device connected via USB, Firewire, SATA, etc.), or via communication links (e.g. via a communication network through the communication interface 130).

The dedicated computer program executed by the processing unit 110 comprises the 3D reconstruction software 112 and the trajectory calculation software 114.

The method 600 comprises the step 605 of storing the process tolerance kinematic model 125 of the robot 300 in the memory 120 of the server 100. Step 605 is performed by the processing unit 110 of the server 100. The process tolerance kinematic model 125 comprises a plurality of active joints of the robot 300 in series and one or more co-located passive joint (as illustrated in FIGS. 5A-C), and further defines a position and orientation of the OCP 331. The position and orientation of the OCP 331 is usually defined with respect to the last active joint of the series of active joints.

As mentioned previously, the plurality of active joints (e.g. 310 to 315) respectively correspond to the plurality of actuated joints of the robot 300, the one or more passive joint (e.g. 340, 341 and 342) simulates a tolerance margin on a position and/or orientation of the tool 330 with respect to an object (e.g. 20B) when the tool 330 performs a task on the object (e.g. 20B). Further details regarding the process tolerance kinematic model 125 have been described previously.

The process tolerance kinematic model 125 is generated by a remote computing device (not represented in FIG. 7) and received via the communication interface 130 of the server 100, to be further stored in the memory 130. Alternatively, the process tolerance kinematic model 125 is generated by the processing unit 110 based at least on: data received from a remote computing device via the communication interface 130 of the server 100 and/or data received from a user via the user interface 140 of the server 100. The generation of the process tolerance kinematic model 125 is an adaptation of the robot kinematic model 124, to take into consideration the process tolerance margin.

The method 600 comprises the step 610 of storing in the memory 120 for each passive joint (e.g. 340, 341 and 342) a nominal joint position of the passive joint and a tolerance margin with respect to the nominal joint position of the passive joint. Step 610 is performed by the processing unit 110. The nominal joint position of the one or more passive joint defines a nominal position and orientation of the tool with respect to the object when the tool performs a task on the object. The tolerance margin of the one or more passive joint defines a tolerance margin on at least one of the nominal position and nominal orientation of the tool with respect to the object when the tool performs the task on the object. Further details regarding the nominal joint position and corresponding tolerance margin of the passive joints have been described previously.

The data related to each passive joint (nominal joint position, tolerance margin) are generated by a remote computing device (not represented in FIG. 7) and received via the communication interface 130, to be further stored in the memory 130. Alternatively, the data related to each passive joint are generated by the processing unit 110 based on: data received from a remote computing device via the communication interface 130 and/or data received from a user via the user interface 140.

The method 600 comprises the step 615 of determining a three-dimensional (3D) model 122 of the object (e.g. 20B). Step 615 is performed by the 3D reconstruction software 112 (executed by the processing unit 110) using imaging data of the object received from the imaging sensor(s) 400 via the communication interface 130. Although not represented in FIG. 7 for simplification purposes, the 3D model 122 of the object is stored in the memory 120.

Alternatively, the 3D model 122 of the object is generated at a remote computing device (not represented in FIG. 7) based on the imaging data generated by the imaging sensor(s) 400, and received by the server 100 via the communication interface 130.

Alternatively, the 3D model does not use imaging data generated by the imaging sensor(s). For example, the 3D model is generated by a computer-aided design (CAD) tool executed by the processing unit 110 of the server 100 or by the remote computing device (not represented in FIG. 7).

The method 600 comprises the step 620 of determining a toolpath 126 of the tool 330 for performing a task on a target area of the object (e.g. 20B). The toolpath 126 comprises a plurality of positions and orientations of the NTP 332. Step 620 is performed by the processing unit 110. Examples of tasks and target areas of the object have been detailed previously. As mentioned previously, each position and orientation of the NTP 332 corresponds to a position and orientation of the OCP 331 where the joint position of each passive joint is the nominal joint position of the passive joint.

The method 600 comprises the step 625 of calculating a trajectory 128 of the articulated arm of the robot 300 based at least on the toolpath 126, the process tolerance kinematic model 125 (comprising the plurality of active joints and the one or more co-located passive joint), and the 3D model 122 of the object (e.g. 20B). The trajectory 128 defines a plurality of consecutive joint positions of the actuated joints (e.g. 310 to 315) of the articulated arm of the robot 300. The calculation of the trajectory 128 takes into account the nominal joint position and the tolerance margin with respect to the nominal joint position of each passive joint. Step 625 is performed by the trajectory calculation software 114 executed by the processing unit 110. Details of the calculation of the trajectory 128 have been described previously. As mentioned previously, an example of joint positions of the actuated joints (e.g. 310 to 315) consists of joint coordinates.

The method 600 comprises the step 630 of generating commands for controlling actuation of the actuated joints (e.g. 310 to 315) of the articulated arm of the robot 300. The commands are generated according to the calculated trajectory 128. Step 630 is performed by the processing unit 110. The commands are transmitted to the robot controller 200 via the communication interface 130.

As mentioned previously, the commands received from the server 100 are processed by the robot controller 200, to generate electrical control currents transmitted to the robot 300. The robot 300 actuates the at least one motor of each actuated joint (e.g. 310 to 315) of its articulated arm according to the received electrical control currents, executing the trajectory 128 calculated at step 625. The execution of the trajectory 128 results in an execution of the toolpath 126 (determined at step 620), which results in executing a trajectory of the OCP 331 of the tool secured to the articulated arm of the robot 300. The execution of the toolpath 126 performs the task (e.g. painting, welding or coating) on the target area of the object (e.g. 22B) processed by the robot 300, taking into consideration the process tolerance margin simulated by the process tolerance kinematic model 125.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for calculating a trajectory of an articulated arm of a robot, the method comprising:
storing in a memory of a computing device a kinematic model of the robot, the robot comprising the articulated arm and a tool coupled to the articulated arm, the articulated arm comprising a plurality of actuated joints in series, the kinematic model comprising a plurality of active joints in series and one or more co-located passive joint, the plurality of active joints respectively corresponding to the plurality of actuated joints, the kinematic model further defining a position and orientation of an operation center point (OCP);
storing in the memory of the computing device for each passive joint a nominal joint position of the passive joint and a tolerance margin with respect to the nominal joint position of the passive joint, the nominal joint position of the one or more passive joint defining a nominal position and orientation of the tool with respect to the object when the tool performs a task on the object, the tolerance margin of the one or more passive joint defining a tolerance margin on at least one of the nominal position and nominal orientation of the tool with respect to the object when the tool performs the task on the object;
determining a three-dimensional (3D) model of the object;
determining a toolpath of the tool for performing the task on a target area of the object, the toolpath comprising a plurality of consecutive positions and orientations of a nominal tool point (NTP), each position and orientation of the NTP corresponding to a position and orientation of the OCP where the joint position of each passive joint is the nominal joint position of the passive joint; and
calculating by a processing unit of the computing device a trajectory of the articulated arm based at least on the toolpath, the kinematic model comprising the plurality of active joints and the one or more co-located passive joint, and the 3D model of the object, the trajectory defining a plurality of consecutive joint positions of the actuated joints of the articulated arm, the calculation of the trajectory taking into account the nominal joint position and the tolerance margin with respect to the nominal joint position of each passive joint.

2. The method of claim 1, wherein the nominal joint position comprises a nominal angle of rotation and the tolerance margin comprises at least one of a minimum and a maximum angle of rotation.

3. The method of claim 1, wherein the nominal joint position comprises a nominal linear displacement and the tolerance margin comprises at least one of a minimum and a maximum linear displacement.

4. The method of claim 1, wherein the operation center point consists of a tool center point located on the tool.

5. The method of claim 1, wherein a cost function is defined for each passive joint, the cost function allocating a cost value for each joint position of the passive joint within the tolerance margin with respect to the nominal joint position of the passive joint, and the calculation of the trajectory further takes into consideration the cost function of each of the one or more passive joint.

6. The method of claim 5, wherein the cost function simulates the action of a spring being at rest at the nominal joint position of the passive joint and being at a maximum extension when the passive joint reaches a joint position corresponding to a limit of the tolerance margin of the passive joint.

7. The method of claim 1, wherein the calculation of the trajectory further takes into consideration a relative movement of the object with respect to the robot.

8. The method of claim 1, wherein the kinematic model comprises the plurality of active joints in series and one passive joint, the plurality of active joints in series and two co-located passive joints, the plurality of active joints in series and three co-located passive joints, or the plurality of active joints in series and four co-located passive joints.

9. The method of claim 1, wherein the kinematic model comprises the plurality of active joints in series and four co-located passive joints, the four co-located passive joints comprising three rotational joints and one linear joint.

10. The method of claim 1, wherein the articulated arm comprises at least six actuated joints in series and the kinematic model comprises at least six active joints in series respectively corresponding to the at least six actuated joints.

11. The method of claim 1, wherein the target area of the object comprises at least one of a surface of the object, a section of a surface of the object, an edge of the object or a summit of the object.

12. The method of claim 1, wherein the 3D model of the object is generated by the processing unit of the computing device based on imaging data received from at least one imaging sensor or the 3D model of the object is received from a remote computing device via a communication interface of the computing device.

13. The method of claim 1, wherein each actuated joint of the articulated arm of the robot is independently actuated by at least one motor.

14. The method of claim 13, further comprising generating by the processing unit of the computing device commands for controlling actuation of the at least one motor of each actuated joint of the articulated arm of the robot according to the calculated trajectory.

15. The method of claim 14, further comprising transmitting the commands to a robot controller controlling the robot via a communication interface of the computing device.

16. The method of claim 1, wherein the task performed by the tool on the object consists of an industrial process.

17. The method of claim 16, wherein the industrial process comprises surface treatments, welding or material removal.

18. A non-transitory computer program product comprising instructions executable by a processing unit of a computing device, the execution of the instructions by the processing unit of the computing device providing for calculating a trajectory of an articulated arm of a robot by:
storing in a memory of the computing device a kinematic model of the robot, the robot comprising the articulated arm and a tool coupled to the articulated arm, the articulated arm comprising a plurality of actuated joints in series, the kinematic model comprising a plurality of active joints in series and one or more co-located passive joint, the plurality of active joints respectively corresponding to the plurality of actuated joints, the kinematic model further defining a position and orientation of an operation center point (OCP);
storing in the memory of the computing device for each passive joint a nominal joint position of the passive joint and a tolerance margin with respect to the nominal joint position of the passive joint, the nominal joint position of the one or more passive joint defining a nominal position and orientation of the tool with respect to the object when the tool performs a task on the object, the tolerance margin of the one or more passive joint defining a tolerance margin on at least one of the nominal position and nominal orientation of the tool with respect to the object when the tool performs the task on the object;
determining by the processing unit of the computing device a three-dimensional (3D) model of the object;
determining by the processing unit of the computing device a toolpath of the tool for performing the task on a target area of the object, the toolpath comprising a plurality of consecutive positions and orientations of a nominal tool point (NTP), each position and orientation of the NTP corresponding to a position and orientation of the OCP where the joint position of each passive joint is the nominal joint position of the passive joint; and
calculating by the processing unit of the computing device a trajectory of the articulated arm based at least on the toolpath, the kinematic model comprising the plurality of active joints and the one or more co-located passive joint, and the 3D model of the object, the trajectory defining a plurality of consecutive joint positions of the actuated joints of the articulated arm, the calculation of the trajectory taking into account the nominal joint position and the tolerance margin with respect to the nominal joint position of each passive joint.

19. A computing device comprising:
memory; and
a processing unit comprising one or more processor for:
storing in the memory a kinematic model of the robot, the robot comprising the articulated arm and a tool coupled to the articulated arm, the articulated arm comprising a plurality of actuated joints in series, the kinematic model comprising a plurality of active joints in series and one or more co-located passive joint, the plurality of active joints respectively corresponding to the plurality of actuated joints, the kinematic model further defining a position and orientation of an operation center point (OCP);
storing in the memory for each passive joint a nominal joint position of the passive joint and a tolerance margin with respect to the nominal joint position of the passive joint, the nominal joint position of the one or more passive joint defining a nominal position and orientation of the tool with respect to the object when the tool performs a task on the object, the tolerance margin of the one or more passive joint defining a tolerance margin on at least one of the nominal position and nominal orientation of the tool with respect to the object when the tool performs the task on the object;
determining a three-dimensional (3D) model of the object;
determining a toolpath of the tool for performing the task on a target area of the object, the toolpath comprising a plurality of consecutive positions and orientations of a nominal tool point (NTP), each position and orientation of the NTP corresponding to a position and orientation of the OCP where the joint position of each passive joint is the nominal joint position of the passive joint; and
calculating a trajectory of the articulated arm based at least on the toolpath, the kinematic model comprising the plurality of active joints and the one or more co-located passive joint, and the 3D model of the object, the trajectory defining a plurality of consecutive joint positions of the actuated joints of the articulated arm, the calculation of the trajectory taking into account the nominal joint position and the tolerance margin with respect to the nominal joint position of each passive joint.
